(19) United States
(12) Patent Application Publication
(10) Pub. No.: US 2024/0025458 A1
(43) Pub. Date: Jan. 25, 2024

(54) VEHICLE CONTROL SYSTEM AND METHOD

(71) Applicant: Transportation IP Holdings, LLC, Norwalk, CT (US)

(72) Inventors: Harry Kirk Mathews, JR., Clifton Park, NY (US); Sarah Felix, Niskayuna, NY (US); Gayathri Indra Seenumani, Niskayuna, NY (US); Kalpesh Singal, Ballston Spa, NY (US); Etika Agarwal, Bangalore (IN)

(21) Appl. No.: 18/344,029

(22) Filed: Jun. 29, 2023

Related U.S. Application Data
(60) Provisional application No. 63/391,835, filed on Jul. 25, 2022.

(51) Int. Cl. B61C 15/00; B61C 3/00

(52) U.S. Cl. CPC B61C 15/00; B61C 3/00

(57) ABSTRACT

A method and control system includes controlling operation of a vehicle system according to a first set of operating conditions while the vehicle system is moving along a route. The vehicle system including plural vehicles with two or more vehicles of the vehicle system contributing a predetermined amount of effort to propel the vehicle system to move along the route based on the first set of operating conditions. Responsive to determining a revised amount of effort that at least one of the two or more vehicles of the vehicle system needs to contribute to propel the vehicle system to control one or more performance variables of the vehicle system, the vehicle system may be automatically controlled according to a second set of operating conditions. At least one vehicle may contribute the revised amount of effort while the vehicle system operates according to the second set of operating conditions.

### CROSS-REFERENCE TO RELATED APPLICATIONS

The application claims priority to U.S. Provisional Application No. 63/391,835, filed on 25 Jul. 2022. The entirety of this application is incorporated herein by reference.

### BACKGROUND

### Technical Field

The subject matter described herein relates to systems and methods for controlling propulsion-generating vehicles in a multi-vehicle system.

### Discussion of Art

Some known vehicle systems can include several propulsion-generating vehicles that are coupled with each other to push and/or pull other vehicles (e.g., non-propulsion-generating vehicles). For example, some rail vehicle systems include several locomotives and rail cars or passenger cars interconnected with each other. Different control schemes can be used to coordinate movements of the propulsion-generating vehicles with each other to ensure that the propulsion and/or braking efforts generated by the different vehicles safely move the vehicle system along a route.

As one example, distributed power (DP) control can be used to control multiple locomotives that are not adjacent to each other. For example, the locomotives can be distributed throughout the length of a vehicle system and are not adjacent to each other. A lead locomotive can send signals to the other locomotives to direct throttle and/or brake settings of the other locomotives.

One problem with DP control is the ability to make real time adjustments to power contributions by different vehicles while the multi-vehicle system is moving. For example, before the vehicle system embarks on a trip, the vehicle system may generate and/or receive power control commands indicating operational control settings for the locomotives at different times, distances, or locations as the multi-vehicle system moves along the route on the trip. However, the vehicle system may come across unexpected route conditions, route conditions that differ from what were anticipated, or the like. A need exists for a system and method that allows for real time adjustments to the distributed power control of the different locomotives of a vehicle system that addresses the shortcomings of currently known systems and methods.

### BRIEF DESCRIPTION

In accordance with one aspect or example, a method may include controlling operation of a vehicle system according to a first set of operating conditions while the vehicle system is moving along a route. The vehicle system may include plural vehicles that may move together along the route. Two or more vehicles of the vehicle system may each contribute a predetermined amount of effort to propel the vehicle system to move along the route based on the first set of operating conditions. The effort may be tractive effort and/or braking effort. Responsive to determining a revised amount of effort that at least one of the two or more vehicles of the vehicle system needs to contribute to propel the vehicle system to control one or more performance variables of the vehicle system, control of the vehicle system may be changed from being controlled according to the first set of operating conditions to automatically controlling operation of the vehicle system according to a second set of operating conditions. The at least one vehicle may contribute the revised amount of effort while the vehicle system operates according to the second set of operating conditions.

In accordance with one aspect or example, a control system may include one or more processors that control operation of a vehicle system according to a first set of operating conditions while the vehicle system is moving along a route. Two or more vehicles of the vehicle system may each contribute a predetermined amount of effort to control movement of the vehicle system to move along the route based on the first set of operating conditions. The effort may be tractive effort and/or braking effort. The processors may determine a revised amount of effort that each of the two or more vehicles of the vehicle system needs to contribute to propel the vehicle system and to control one or more performance variables of the plural vehicles. Responsive to a determination of a revised amount of effort that at least one of the two or more vehicles of the vehicle system needs to contribute to propel the vehicle system to control one or more performance variables of the plural vehicles, the one or more processors may change from controlling the vehicle system according to the first set of operating conditions to automatically controlling operation of the vehicle system according to a second set of operating conditions. At least one of the two or more vehicles may contribute the revised amount of effort while the vehicle system operates according to the second set of operating conditions.

In accordance with one aspect or example, a method may include one or more of generating or receiving a first set of operating conditions for controlling operation of a vehicle system according to the first set of operating conditions before the vehicle system starts moving along a route. The vehicle system may include plural vehicles. The first set of operating conditions specifying a predetermined amount of effort that each of two or more vehicles of the vehicle system is to contribute to propel the vehicle system to move along the route. A revised amount of effort that one or more vehicles of the vehicle system needs to contribute to propel the vehicle system may be determined to control one or more performance variables of the plural vehicles while the vehicle system is moving along the route. Control of the vehicle system may change from controlling the vehicle system according to the first set of operating conditions to automatically controlling operation of the vehicle system according to a second set of operating conditions.

### BRIEF DESCRIPTION OF THE DRAWINGS

The inventive subject matter may be understood from reading the following description of non-limiting embodiments, with reference to the attached drawings, wherein below:

FIG. 1 illustrates one example of a multi-vehicle system in accordance with one embodiment;

FIG. 2 illustrates a propulsion-generating vehicle of the vehicle system show in FIG. 1;

FIG. 3 illustrates a flowchart of one example of a method for controlling operation of a vehicle system;

FIG. 4 illustrates a schematic of one example for determining efforts by propulsion-generating vehicles to contribute for controlling operation of a vehicle system moving along a route; and

FIG. 5 illustrates a schematic of another example for determining efforts by propulsion-generating vehicles to contribute for controlling operation of a vehicle system moving along a route.

### DETAILED DESCRIPTION

Embodiments of the subject matter described herein relate to vehicle control systems and methods. In some embodiments, the vehicle system may be a multi-vehicle system, and two or more propulsion-generating vehicles of the system may be controlled to be operated according to a first set of operating conditions while the vehicle system is moving. Operating according to the first set of operating conditions may enable the two or more propulsion-generating vehicles to contribute an amount of effort to propel the vehicle system to move along the route. The effort may be tractive effort and/or braking effort.

In some embodiments, while the vehicle system is moving along the route, a determination may be made of a revised amount of effort that at least one propulsion-generating vehicle needs to contribute to propel the vehicle system. The revised amount of effort may be to control one or more performance variables of the vehicle system. The performance variables may include forces between adjacent or neighboring vehicles, forces on couplers or coupling features between adjacent vehicles, states of the couplers, a state of charge of an energy storage device of the vehicle system, or the like. Responsive to determining the revised amount of effort, the vehicle system may change from being controlled according to the first set of operating conditions to being automatically controlled according to a second set of operating conditions. At least one propulsion-generating vehicle may contribute the revised amount of effort while the vehicle system operates according to the second set of operating conditions.

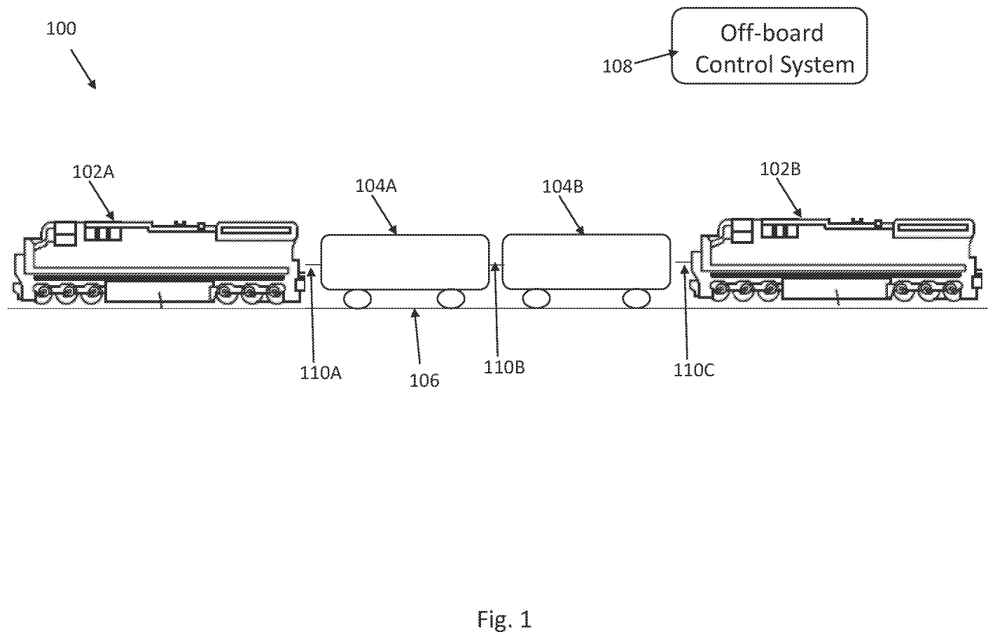

FIG. 1 illustrates one example of a multi-vehicle system 100. The vehicle system is formed from multiple propulsion-generating vehicles 102A, 102B, and one or more non-propulsion-generating vehicles 104A, 104B. The number and/or arrangement of the vehicles 102, 104 in the vehicle system may differ from what is shown in FIG. 1. In the illustrated embodiment, the propulsion-generating vehicles are locomotives and the non-propulsion-generating vehicles are rail cars, but alternatively, these vehicles may not be rail vehicles. For example, the vehicles may be automobiles, trucks (with or without trailers), buses, aircraft (e.g., fixed wing, drones, rotary wing, etc.), mining vehicles, agricultural vehicles, marine vessels, or the like. The multi-vehicle systems described herein (rail vehicle systems or other vehicle systems that do not travel on rails or tracks) can be formed with vehicles mechanically coupled with each other (e.g., by couplers), or can be logically coupled without being mechanically coupled. For example, vehicles may be logically but not mechanically coupled when the separate vehicles communicate with each other to coordinate movements of the vehicles with each other so that the vehicles travel together (e.g., as a convoy, swarm, platoon, fleet, or the like).

The neighboring or adjacent vehicles in the vehicle system are mechanically coupled with each other by couplers 110A-C. Alternatively, two or more of the vehicles may be logically coupled but not mechanically coupled, such as where the logically coupled vehicles are separate by communicate with each other to coordinate movements (e.g., to travel as a convoy).

In the illustrated embodiment, the vehicle 102A can be referred to as a lead propulsion-generating vehicle, as this vehicle controls or directs the operational settings of the remote propulsion-generating vehicle 102B to control movement of the vehicle system along a route 106. While the lead vehicle is shown at a leading end of the vehicle system, the lead vehicle may be in another location in the consist. In one or more embodiments, the lead vehicle may issue commands via control signals that are directly or indirectly communicated (wirelessly and/or wired communication) to the other propulsion-generating vehicle(s) in the vehicle system. The lead vehicle may generate or create the control signals (such as via an energy management system of the lead vehicle) that are communicated to the other propulsion-generating vehicles.

Optionally, the lead vehicle, and/or the other propulsion-generating vehicle may receive control signals from an off-board control system 108. The off-board control system can represent hardware circuitry that includes or is connected with one or more processors (e.g., one or more integrated circuits, field programmable gate arrays, microprocessors, or the like), that perform one or more of the operations described herein. In one embodiment, the off-board control system may communicate the control signals to the lead propulsion-generating vehicle, and the lead propulsion-generating vehicle may relay (the same control signals or modified control signals) to each of the other propulsion-generating vehicles. In another embodiment, the off-board control system may communicate control signals to each of the propulsion-generating vehicles of the vehicle system.

The control signals may dictate operational settings of the propulsion-generating vehicles as a function of time, distance, and/or location (e.g., to reduce consumed fuel, generated emissions, generated noise, or the like). The operational settings of each of the different propulsion-generating vehicles may control efforts provided by each of the propulsion-generating vehicles to control movement of the vehicle system and to propel the vehicle system to move along the route. For example, distributed power (DP) control may be used to control multiple propulsion-generating vehicles distributed throughout the length of the vehicle system and an amount of effort provided by each of the propulsion-generating vehicles. The efforts may be braking efforts, tractive efforts, or a combination of the two. For example, the lead vehicle may be directed to operate according to first operating settings at a first location to contribute a first amount of effort, and the remote propulsion-generating vehicle may be directed to operate according to second operating settings (that may be different than or the same as the first operating settings) at the first location to contribute a second amount of effort.

The operating settings of the propulsion-generating vehicles may be determined based on the time, distance, and/or location of the vehicles to coordinate the efforts provided by each of the vehicles at the different times, distances, and/or locations along the route. For example, the lead propulsion-generating vehicle may be operated to contribute a first amount of effort (e.g., tractive effort), and the remote propulsion-generating vehicle may be operated to contribute a different, second amount of effort (e.g., tractive effort) at a location along the route. The different contributions of efforts may be to control one or more performance variables of the vehicle system. The performance variables may include, but are not limited to, forces between adjacent vehicles of the vehicle system (e.g., tension forces, compression forces, or the like), forces on couplers between the adjacent vehicles, states of different couplers between adjacent vehicles (e.g., a health state of the couplers, an amount of wear, an age of the couplers, or the like), a state of charge of an energy storage device of the vehicle system (e.g., a battery, or the like), or the like.

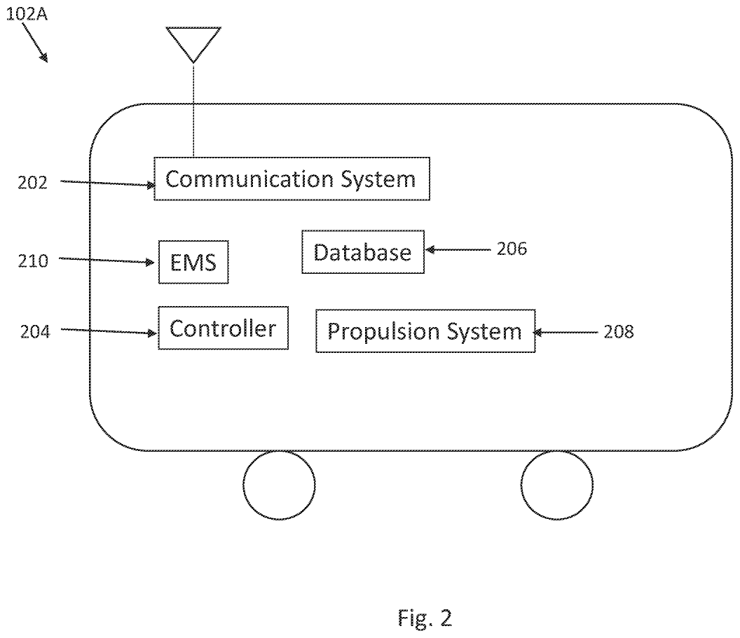

FIG. 2 illustrates one example of one of the propulsion-generating vehicles of the vehicle system shown in FIG. 1. The vehicle includes a controller 204 that represents hardware circuitry that includes or is connected with one or more processors (e.g., one or more integrated circuits, field programmable gate arrays, microprocessors, or the like) that perform the operations described herein. The vehicle includes a communication system 202 that represents transceiving hardware (e.g., antennas, wires, cables, modems, codecs, or the like) that wirelessly communicate the signals or communicate the signals described herein via wired connections.

In response to receiving a control signal or based on a received control signal (e.g., generated by the off-board controller and received by the propulsion-generating vehicles, generated by the lead propulsion-generating vehicle and received by the other propulsion-generating vehicles, or the like), the controller can direct a propulsion system 208 onboard the corresponding propulsion-generating vehicle to generate tractive effort and/or braking effort according to the control signal. The propulsion system can represent one or more engines, alternators, generators, motors, or the like, that operate to propel the vehicle (and vehicle system) and/or brake the vehicle or vehicle system (e.g., using dynamic braking).

The vehicle can include an energy management system (EMS) 210 that represents hardware circuitry that includes or is connected with one or more processors that determine operational settings of the vehicle system. For example, the energy management system can determine throttle settings, speeds, brake settings, accelerations, or the like, for different vehicles at different times, locations, distances, etc., to cause the vehicle system to arrive at a location within a scheduled time but while consuming less fuel, consuming less electric energy, generating less noise, and/or generating fewer emissions when compared to the same vehicle system arriving at the same location within the same scheduled time but using different operational settings. The energy management system may store information or access information on a profile of the vehicle system from a database 206 to determine the operational settings. The profile can indicate or identify which propulsion-generating vehicles are in the vehicle system, locations of the different propulsion-generating vehicles (e.g., relative to each other propulsion-generating vehicles, a geospatial location of the vehicles, or the like), locations of non-propulsion-generating vehicles, a weight of one or more of the vehicles, a combined weight of the vehicle system, types of couplers between the adjacent vehicles, or the like.

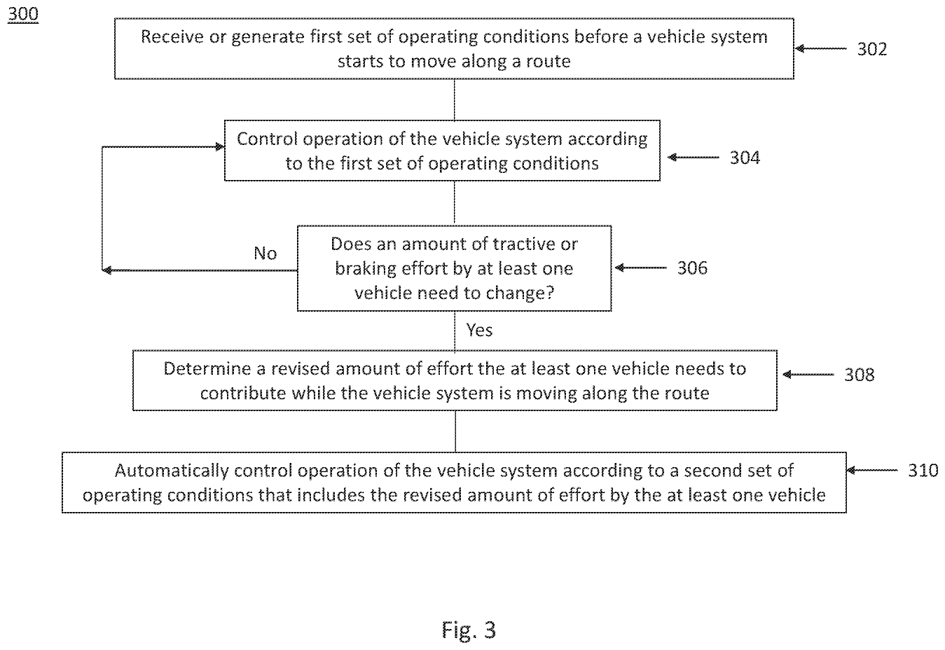

FIG. 3 illustrates a flowchart 300 of one example of a method for controlling movement of a vehicle system. The method can represent operations performed by the controller(s) of the propulsion-generating vehicles and/or the off-board control system shown in FIGS. 1 and 2 to control movement of a multi-vehicle system shown in FIG. 1.

At step 302, a first set of operating conditions may be received by the vehicle system while the vehicle system is stationary and before the vehicle system starts to move along the route, such as for a trip. The first set of operating conditions may be generated by the off-board control system and communicated to the vehicle system. Optionally, the lead propulsion-generating vehicle may generate the first set of operating conditions, and the other propulsion-generating vehicles may receive the first set of operating conditions from the lead propulsion-generating vehicle.

The first set of operating conditions may include one or more operating settings for the propulsion-generating vehicles at one or more locations along the route. For example, the first set of operating conditions includes the predetermined amount of effort for the two or more propulsion-generating vehicles at the one or more locations along the route. The first set of operating conditions may be based on route grades and route curvatures of the trip, anticipated environmental conditions in which the vehicle system is expected to be subjected to, a state of charge of one or more energy storage devices of the vehicle system, or the like. The first set received by the lead vehicle may direct the lead vehicle to operate having a first throttle setting at a first location along the route, operate having a second throttle setting at a second location along the route, operate having a first brake setting at a third location along the route, or the like.

At step 304, the propulsion-generating vehicles may be controlled according to the first set of operating conditions to propel the vehicle system to move along the route. In one embodiment, the off-board control system may remotely control operation of the vehicle system according to the first set of operating conditions. In another embodiment, the lead propulsion-generating vehicle may control the propulsion system of the lead vehicle, and may remotely control the propulsion system of the remote propulsion-generating vehicle. In another embodiment, the controllers of the propulsion-generating vehicles may control the propulsion systems of the corresponding vehicles to operate according to the first set of operating conditions.

The first set of operating conditions may be based on a predetermined amount of effort (e.g., tractive effort and/or braking effort) the different propulsion-generating vehicles are to produce to contribute to the vehicle system to move the vehicle system along the route. For example, the first set of operating conditions may indicate throttle or brake settings for controlling the different propulsion-generating vehicles at different locations, times, and/or distances along the route. The propulsion-generating vehicles can collectively produce a tractive effort and/or braking effort, such as to control forces imparted on couplers between the vehicles in the vehicle system, at the different locations along the route.

At step 306, while the vehicle system is moving along the route, a determination is made whether an amount of effort by one or more of the propulsion-generating vehicles needs to change. The amount of effort (e.g., tractive effort and/or braking effort) by one or more of the propulsion-generating vehicles may need to change based on the one or more performance variables of the vehicle system (e.g., forces between successive or adjacent vehicles, forces on couplers between adjacent vehicles, current states of charge of energy storage devices providing electric power to the vehicle system, or the like). In one embodiment, while the vehicle system is moving along the route, a determination may be made that the lead propulsion-generating vehicle, operating according to the first set of operating conditions (e.g., providing a predetermined first amount of tractive effort), may need to provide a revised amount of tractive effort to contribute to propel the vehicle system. For example, the predetermined first amount of tractive effort may be resulting in forces between two or more adjacent vehicles nearing or exceeding a predetermined force threshold (e.g., the adjacent vehicles are stretched too far apart, are bunched too closely together, or the like). The controller(s) of the vehicles and/or the off-board control system may determine that one or more propulsion-generating vehicles may need to contribute a revised amount of effort instead of the predetermined amount of effort, at one or more locations along the route.

If it is determined that none of the propulsion-generating vehicles need to contribute a different or revised amount of effort, or that the predetermined amount of effort is sufficient, then flow of the method returns to step 304, and the vehicle system continues to be controlled according to the first set of operating conditions. Alternatively, if it is determined that the predetermined amount of effort being contributed by at least one propulsion-generating vehicle is insufficient, flow of the method proceeds toward step 308.

At step 308, a revised amount of effort that the at least one propulsion-generating vehicle needs to contribute is determined. For example, the revised amount of effort may be determined while the vehicle system is moving along the route. The revised amount of effort may be determined based on a current speed of movement of the vehicle system, environmental conditions in which the vehicle system is moving, route grades, route curvatures, a total amount of effort from the plural propulsion-generating vehicles of the vehicle system, a state of charge of one or more vehicles (or one or more energy storage devices of the one or more vehicles) of the vehicle system, or the like.

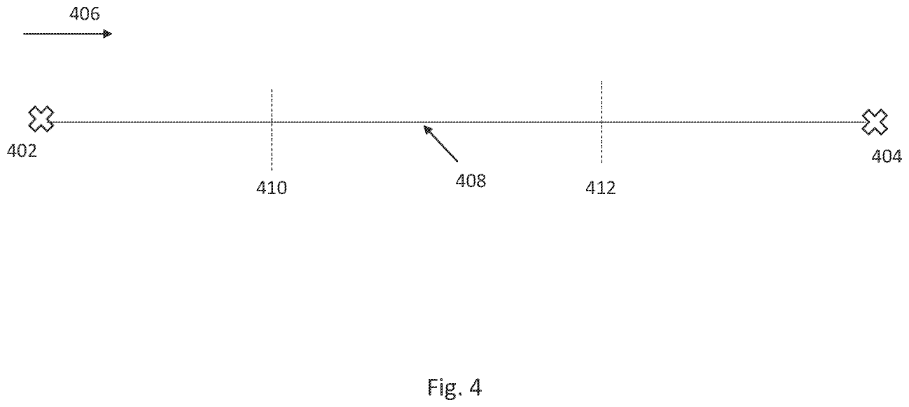

FIG. 4 illustrates a schematic of one example for determining the revised amount of effort and for controlling operation of the vehicle system. A vehicle system, such as illustrated in FIG. 1, may move along a route 408 in a direction of travel 406 between a start location 402 and an end location 404. Before the vehicle system starts the trip or starts moving away from the start location, the vehicle system may receive and/or generate the first set of operating conditions indicative of how the vehicle system should be controlled at one or more locations along the route between the start and end locations. For example, a first propulsion-generating vehicle may be controlled to contribute a first amount of predetermined effort, and a second propulsion-generating vehicle may be controlled to contribute a second amount of predetermined effort (which may be the same or different than the first amount of predetermined effort) between the start location and a first waypoint location 410.

Responsive to reaching, or being within a determined threshold distance away from the first waypoint location, the off-board control system, the controllers of the vehicle system, or the energy management system(s) of the propulsion-generating vehicles may determine a revised amount of effort that the at least one propulsion-generating vehicle should contribute to propel the vehicle system. The revised amount of effort may be determined based on one or more current performance variables of the vehicle system, based on current conditions of the route along which the vehicle system is moving, based on a comparison between the current conditions and anticipated conditions (e.g., the actual grade is different than the anticipated grade of the route, the actual forces between adjacent vehicles is different than anticipated forces between adjacent vehicles, the actual environmental conditions are different than anticipated environmental conditions, or the like), or the like.

In one embodiment, the predetermined amount of effort of a first propulsion-generating vehicle may be compared with the determined revised amount of effort of the first propulsion-generating vehicle to determine whether the predetermined amount of effort needs to change. For example, the predetermined amount of effort may be compared with the determined revised amount of effort, and it may be determined that the predetermined amount of effort is sufficient to control operation of the vehicle system based on the performance variables of the vehicle system. Alternatively, it may be determined that one or more of the vehicles may need to contribute the revised amount of effort. The revised amount of effort may be associated with different operating conditions of the vehicle system relative to the first set of operating conditions. For example, a first vehicle may contribute a first amount of the predetermined effort while the first vehicle operates according to the first set of operating conditions, and the first vehicle may contribute a second amount of revised effort that is different than the first amount of the predetermined effort while the first vehicle operates according to a different, second set of operating conditions.

Returning to FIG. 3, at step 310, one or more processors of the controllers of the vehicle system may automatically change from controlling the vehicle system according to the first set of operating conditions to automatically controlling operation of the vehicle system according to the second set of operating conditions. At least one propulsion-generating vehicle may contribute a revised amount of effort while the vehicle system operates according to the second set of operating conditions. In one or more embodiments, controlling operation of the vehicle system according to the second set of operating conditions changes an amount of force (e.g., tension or compression) between at least two successive or adjacent vehicles of the vehicle system relative to controlling operation of the vehicle system according to the first set of operating conditions. In one or more embodiments, controlling operation of the vehicle system according to the second set of operating conditions changes a distance between at least two successive or adjacent vehicles relative to controlling operation of the vehicle system according to the first set of operating conditions.

In one or more embodiments, it may be determined that two or more propulsion-generating vehicles may need to contribute revised amounts of effort compared to the predetermined amounts of effort of each vehicle, respectively. As one example, a first vehicle may contribute a first amount of revised effort, and a second vehicle may contribute a second amount of revised effort while the first and second vehicles are controlled to operate according to the second set of operating conditions. The first and second revised amounts may be substantially the same amounts of effort, may be different amounts of effort, may be different types of effort (e.g., braking effort and/or tractive effort), or the like.

The vehicle system may automatically be controlled to operate according to the second set of operating conditions while the vehicle system moves between the first waypoint location and a second waypoint location 412 (shown in FIG. 4). Responsive to reaching, or being within a determined threshold distance away from the second waypoint location, new revised amounts of effort for the two or more propulsion-generating vehicles may again be determined based at least on current conditions of the route at or within a distance range of the second waypoint location. The new revised amount of effort (corresponding to the second waypoint location) may be compared with the predetermined amount of effort that the vehicle system received before the vehicle system started moving along the route to determine how the vehicle system should be operated (e.g., according to the first set of operating conditions based on the predetermined amount of effort, or according to a third set of operating conditions based on the new revised amount of effort corresponding to the second waypoint location).

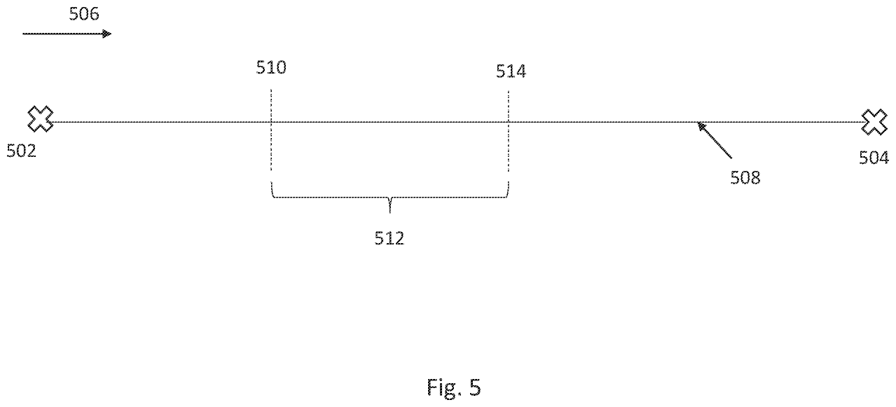

In the illustrated embodiment of FIG. 4, the revised amount of effort is determined based at least in part on current conditions of the route along which the vehicle system is moving. Alternatively, the revised amount of effort may be determined based on upcoming conditions of the route. For example, FIG. 5 illustrates a schematic of another example for determining the revised amount of effort and for controlling operation of the vehicle system. Like the schematic shown in FIG. 4, FIG. 5 includes a route 508 that extends between a start location 502 and an end location 504. A multi-vehicle system (e.g., the vehicle system shown in FIG. 1) moves along the route in a direction of movement 506 from the start location to the end location.

Before the vehicle system starts the trip or starts moving away from the start location, the vehicle system may receive and/or generate the first set of operating conditions indicative of how the vehicle system should be controlled at the one or more locations along the route between the start and end locations. Responsive to the vehicle system reaching, or being within a determined threshold distance from a first waypoint location 510, one or more controllers of the vehicle system may determine that the predetermined amount of effort being contributed by at least one propulsion-generating vehicle is insufficient, and may determine a revised amount of effort that at least one propulsion-generating vehicle should contribute to propel the vehicle system. The revised amount of effort may be determined based at least in part on conditions of the route within a threshold distance 512 ahead of the first waypoint location. For example, the one or more controllers may look at conditions of the route within the upcoming threshold distance, and may compare the conditions of the route with anticipated conditions that were used to determine the predetermined amounts of efforts.

In the illustrated embodiment, the threshold distance extends between the first waypoint location and a second waypoint location 514. In one embodiment, the threshold distance may be based on a length of the vehicle system, such as a percentage of the length of the vehicle system, the threshold distance may be substantially the same as the length of the vehicle system, or the like. Optionally, the threshold distance may be based on a geospatial or governmental divide (e.g., a city limit line, a county line, a state line, a country border, or the like). Optionally, the threshold distance may be based on changes to the route (e.g., the threshold distance may extend to an entrance of a tunnel, may extend to an entrance of a bridge, or the like).

The controller may determine the revised amount of effort by looking at conditions of the route within the threshold distance ahead of the vehicle system in the direction of movement of the vehicle system. Additionally, the controller may compare the different predetermined amounts of effort of vehicles the vehicle system with the determined revised amounts of effort to determine whether the predetermined amount of effort for at least one propulsion-generating vehicle needs to change. The revised amount of effort may be associated with different operating conditions (e.g., a second set of operating conditions) of the vehicle system relative to the first set of operating conditions (e.g., associated with the predetermined amounts of effort).

If it is determined that one or more vehicles needs to contribute the revised amount of effort, the controllers may automatically change from controlling the vehicle system according to the first set of operating conditions to automatically controlling operation of the vehicle system according to the second set of operating conditions. At least one propulsion-generating vehicle may contribute a revised amount of effort while the vehicle system operates according to the second set of operating conditions.

In one embodiment, the controllers or systems described herein may have a local data collection system deployed and may use machine learning to enable derivation-based learning outcomes. The controllers may learn from and make decisions on a set of data (including data provided by the various sensors), by making data-driven predictions and adapting according to the set of data. In embodiments, machine learning may involve performing a plurality of machine learning tasks by machine learning systems, such as supervised learning, unsupervised learning, and reinforcement learning. Supervised learning may include presenting a set of example inputs and desired outputs to the machine learning systems. Unsupervised learning may include the learning algorithm structuring its input by methods such as pattern detection and/or feature learning. Reinforcement learning may include the machine learning systems performing in a dynamic environment and then providing feedback about correct and incorrect decisions. In examples, machine learning may include a plurality of other tasks based at least in part on an output of the machine learning system. In examples, the tasks may be machine learning problems such as classification, regression, clustering, density estimation, dimensionality reduction, anomaly detection, and the like. In examples, machine learning may include a plurality of mathematical and statistical techniques. In examples, the many types of machine learning algorithms may include decision tree based learning, association rule learning, deep learning, artificial neural networks, genetic learning algorithms, inductive logic programming, support vector machines (SVMs), Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based at least in part on natural selection). In an example, the algorithm may be used to address problems of mixed integer programming, where some components restricted to being integer-valued. Algorithms and machine learning techniques and systems may be used in computational intelligence systems, computer vision, Natural Language Processing (NLP), recommender systems, reinforcement learning, building graphical models, and the like. In an example, machine learning may be used making determinations, calculations, comparisons and behavior analytics, and the like.

In one embodiment, the controllers may include a policy engine that may apply one or more policies. These policies may be based at least in part on characteristics of a given item of equipment or environment. With respect to control policies, a neural network can receive input of a number of environmental and task-related parameters. These parameters may include, for example, operational input regarding operating equipment, data from various sensors, location and/or position data, and the like. The neural network can be trained to generate an output based at least in part on these inputs, with the output representing an action or sequence of actions that the equipment or system should take to accomplish the goal of the operation. During operation of one embodiment, a determination can occur by processing the inputs through the parameters of the neural network to generate a value at the output node designating that action as the desired action. This action may translate into a signal that causes the vehicle to operate. This may be accomplished via back-propagation, feed forward processes, closed loop feedback, or open loop feedback. Alternatively, rather than using backpropagation, the machine learning system of the controller may use evolution strategies techniques to tune various parameters of the artificial neural network. The controller may use neural network architectures with functions that may not always be solvable using backpropagation, for example functions that are non-convex. In one embodiment, the neural network has a set of parameters representing weights of its node connections. A number of copies of this network are generated and then different adjustments to the parameters are made, and simulations are done. Once the output from the various models are obtained, they may be evaluated on their performance using a determined success metric. The best model is selected, and the vehicle controller executes that plan to achieve the desired input data to mirror the predicted best outcome scenario. Additionally, the success metric may be a combination of the optimized outcomes, which may be weighed relative to each other.

In accordance with one aspect or example, a method may include controlling operation of a vehicle system according to a first set of operating conditions while the vehicle system is moving along a route. The vehicle system may include plural vehicles that may move together along the route. Two or more vehicles of the vehicle system may each contribute a predetermined amount of effort to propel the vehicle system to move along the route based on the first set of operating conditions. The effort being tractive effort and/or braking effort. Responsive to determining a revised amount of effort that at least one of the two or more vehicles of the vehicle system needs to contribute to propel the vehicle system to control one or more performance variables of the vehicle system, control of the vehicle system may be changed from being controlled according to the first set of operating conditions to automatically controlling operation of the vehicle system according to a second set of operating conditions. The at least one vehicle may contribute the revised amount of effort while the vehicle system operates according to the second set of operating conditions.

Optionally, a first vehicle of the two or more vehicles may contribute a first amount of the predetermined effort while the first vehicle operates according to the first set of operating conditions, and the first vehicle may contribute a second amount of revised effort that is different than the first amount of the predetermined effort while the first vehicle operates according to the second set of operating conditions. Optionally, a first vehicle of the two or more vehicles may contribute a first amount of the revised effort and a second vehicle of the two or more vehicles may contribute a second amount of the revised effort that is different than the first amount of the revised effort contributed by the first vehicle while the first and second vehicles operate according to the second set of operating conditions. Optionally, the first set of operating conditions including the predetermined amount of effort may be generated or received before the vehicle system starts moving along the route. Optionally, the revised amount of effort for each of the two or more vehicles may be determined while the vehicle system is moving along the route. Optionally, the first set of operating conditions may include the predetermined effort for plural locations along the route. Optionally, the revised effort may be determined at one or more of the plural locations along the route.

Optionally, the predetermined amount of effort may be compared with the determined revised amount of effort for each of the two or more vehicles at each of the plural locations. A determination may be made that the predetermined effort needs to change based on the comparison between the predetermined amount of effort and the determined revised amount of effort. Optionally, the revised amount of effort may be determined based on one or more of a current speed of movement of the vehicle system, environmental conditions in which the vehicle system is moving, route grades, route curvatures, a total amount of effort from the plural vehicles of the vehicle system, or a state of charge of one or more vehicles of the vehicle system. Optionally, the revised amount of effort may be determined based at least in part on conditions of the route within a threshold distance ahead of the vehicle system along the route in a direction of travel of the vehicle system. Optionally, the revised amount of effort may be determined based at least in part on current conditions of the route along which the vehicle system is moving. Optionally, controlling operation of the vehicle system according to the second set of operating conditions may change an amount of force between at least two successive vehicles of the vehicle system relative to controlling operation of the vehicle system according to the first set of operating conditions. Optionally, controlling operation of the vehicle system according to the second set of operating conditions may change a distance between at least two successive vehicles of the vehicle system relative to controlling operation of the vehicle system according to the first set of operating conditions.

In accordance with one aspect or example, a control system may include one or more processors that control operation of a vehicle system according to a first set of operating conditions while the vehicle system is moving along a route. Two or more vehicles of the vehicle system may each contribute a predetermined amount of effort to control movement of the vehicle system to move along the route based on the first set of operating conditions. The effort may be tractive effort and/or braking effort. The processors may determine a revised amount of effort that each of the two or more vehicles of the vehicle system needs to contribute to propel the vehicle system and to control one or more performance variables of the plural vehicles. Responsive to a determination of a revised amount of effort that at least one of the two or more vehicles of the vehicle system needs to contribute to propel the vehicle system to control one or more performance variables of the plural vehicles, the one or more processors may change from controlling the vehicle system according to the first set of operating conditions to automatically controlling operation of the vehicle system according to a second set of operating conditions. At least one of the two or more vehicles may contribute the revised amount of effort while the vehicle system operates according to the second set of operating conditions.

Optionally, the processors may one or more of generate or receive the first set of operating conditions including the predetermined amount of effort before the vehicle system starts moving along the route. Optionally, the processors may determine the revised amount of effort while the vehicle system is moving along the route. Optionally, the first set of operating conditions may include the predetermined effort for plural locations along the route. Optionally, the processors may determine the revised effort at one or more of the plural locations along the route. Optionally, the processors may compare the predetermined amount of effort with the determined revised effort at each of the plural locations. The processors may determine that the predetermined effort needs to change based on the comparison between the predetermined effort and the determined revised effort.

Optionally, the revised amount of effort may be determined based on one or more of a current speed of movement of the vehicle system, environmental conditions in which the vehicle system is moving, route grades, or route curvatures.

Optionally, the revised amount of effort may be determined based at least in part on conditions of the route within a predetermined threshold distance ahead of the vehicle system along the route in a direction of travel of the vehicle system. Optionally, the revised amount of effort may be determined based at least in part on current conditions of the route along which the vehicle system is moving. Optionally, controlling operation of the vehicle system according to the second set of operating conditions may change an amount of force between at least two successive vehicles of the vehicle system relative to controlling operation of the vehicle system according to the first set of operating conditions. Optionally, controlling operation of the vehicle system according to the second set of operating conditions may change a distance between at least two successive vehicles of the vehicle system relative to controlling operation of the vehicle system according to the first set of operating conditions. Optionally, the one or more performance variables may include forces between adjacent vehicles of the vehicle system, forces on coupling features between adjacent vehicles, states of the coupling features between adjacent vehicles, or a state of charge of an energy storage device of the vehicle system.

In accordance with one aspect or example, a method may include one or more of generating or receiving a first set of operating conditions for controlling operation of a vehicle system according to the first set of operating conditions before the vehicle system starts moving along a route. The vehicle system may include plural vehicles. The first set of operating conditions specifying a predetermined amount of effort that each of two or more vehicles of the vehicle system is to contribute to propel the vehicle system to move along the route. A revised amount of effort that one or more vehicles of the vehicle system needs to contribute to propel the vehicle system may be determined to control one or more performance variables of the plural vehicles while the vehicle system is moving along the route. Control of the vehicle system may change from controlling the vehicle system according to the first set of operating conditions to automatically controlling operation of the vehicle system according to a second set of operating conditions.

As used herein, the terms “processor” and “computer,” and related terms, e.g., “processing device,” “computing device,” and “controller” may be not limited to just those integrated circuits referred to in the art as a computer, but refer to a microcontroller, a microcomputer, a programmable logic controller (PLC), field programmable gate array, and application specific integrated circuit, and other programmable circuits. Suitable memory may include, for example, a computer-readable medium. A computer-readable medium may be, for example, a random-access memory (RAM), a computer-readable non-volatile medium, such as a flash memory. The term “non-transitory computer-readable media” represents a tangible computer-based device implemented for short-term and long-term storage of information, such as, computer-readable instructions, data structures, program modules and sub-modules, or other data in another device. Therefore, the methods described herein may be encoded as executable instructions embodied in a tangible, non-transitory, computer-readable medium, including, without limitation, a storage device and/or a memory device. Such instructions, when executed by a processor, cause the processor to perform at least a portion of the methods described herein. As such, the term includes tangible, computer-readable media, including, without limitation, non-transitory computer storage devices, including without limitation, volatile and non-volatile media, and removable and non-removable media such as firmware, physical and virtual storage, CD-ROMS, DVDs, and other digital sources, such as a network or the Internet.

As used herein, an element or step recited in the singular and proceeded with the word “a” or “an” do not exclude the plural of said elements or operations, unless such exclusion is explicitly stated. Furthermore, references to “one embodiment” of the invention do not exclude the existence of additional embodiments that incorporate the recited features. Moreover, unless explicitly stated to the contrary, embodiments “comprising,” “comprises,” “including,” “includes,” “having,” or “has” an element or a plurality of elements having a particular property may include additional such elements not having that property. In the appended claims, the terms “including” and “in which” are used as the plain-English equivalents of the respective terms “comprising” and “wherein.” Moreover, in the following claims, the terms “first,” “second,” and “third,” etc. are used merely as labels, and do not impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function devoid of further structure.

The above description is illustrative, and not restrictive. For example, the above-described embodiments (and/or aspects thereof) may be used in combination with each other. In addition, many modifications may be made to adapt a particular situation or material to the teachings of the inventive subject matter without departing from its scope. While the dimensions and types of materials described herein define the parameters of the inventive subject matter, they are exemplary embodiments. Other embodiments will be apparent to one of ordinary skill in the art upon reviewing the above description. The scope of the inventive subject matter should, therefore, be determined with reference to the appended claims, along with the full scope of equivalents to which such claims are entitled.

This written description uses examples to disclose several embodiments of the inventive subject matter, including the best mode, and to enable one of ordinary skill in the art to practice the embodiments of inventive subject matter, including making and using other devices or systems and performing an incorporated method. The patentable scope of the inventive subject matter is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

What is claimed is:

1. A method comprising:
controlling operation of a vehicle system according to a first set of operating conditions while the vehicle system is moving along a route, the vehicle system comprising plural vehicles configured to move together along the route, wherein two or more vehicles of the vehicle system are each configured to contribute a predetermined amount of effort to propel the vehicle system to move along the route based on the first set of operating conditions, the effort being at least one of tractive effort or braking effort; and
responsive to a determination of a revised amount of the effort that at least one of the two or more vehicles of the vehicle system needs to contribute to propel the vehicle system to control one or more performance variables of the vehicle system, changing from controlling the vehicle system according to the first set of operating conditions to automatically controlling operation of the vehicle system according to a second set of operating conditions, wherein the at least one vehicle is configured to contribute the revised amount of effort while the vehicle system operates according to the second set of operating conditions.

2. The method of claim 1, wherein a first vehicle of the two or more vehicles is configured to contribute a first amount of the predetermined effort while the first vehicle operates according to the first set of operating conditions, and the first vehicle is configured to contribute a second amount of revised effort that is different than the first amount of the predetermined effort while the first vehicle operates according to the second set of operating conditions.

3. The method of claim 1, wherein a first vehicle of the two or more vehicles is configured to contribute a first amount of the revised effort and a second vehicle of the two or more vehicles is configured to contribute a second amount of the revised effort that is different than the first amount of the revised effort contributed by the first vehicle while the first and second vehicles operate according to the second set of operating conditions.

4. The method of claim 1, further comprising one or more of generating or receiving the first set of operating conditions including the predetermined amount of effort before the vehicle system starts moving along the route.

5. The method of claim 1, further comprising determining the revised amount of effort for each of the two or more vehicles while the vehicle system is moving along the route.

6. The method of claim 1, wherein the first set of operating conditions includes the predetermined effort for plural locations along the route.

7. The method of claim 6, further comprising determining the revised effort at one or more of the plural locations along the route.

8. The method of claim 6, further comprising:
comparing the predetermined amount of effort with the determined revised amount of effort for each of the two or more vehicles at each of the plural locations; and
determining that the predetermined effort needs to change based on the comparison between the predetermined amount of effort and the determined revised amount of effort.

9. The method of claim 1, wherein the revised amount of effort is determined based on one or more of a current speed of movement of the vehicle system, environmental conditions in which the vehicle system is moving, route grades, route curvatures, a total amount of effort from the plural vehicles of the vehicle system, or a state of charge of one or more vehicles of the plural vehicles of the vehicle system.

10. The method of claim 1, wherein controlling operation of the vehicle system according to the second set of operating conditions changes an amount of force between at least two successive vehicles of the vehicle system relative to controlling operation of the vehicle system according to the first set of operating conditions.

11. The method of claim 1, wherein controlling operation of the vehicle system according to the second set of operating conditions changes a distance between at least two successive vehicles of the vehicle system relative to controlling operation of the vehicle system according to the first set of operating conditions.

12. A control system comprising:
one or more processors configured to control operation of a vehicle system according to a first set of operating conditions while the vehicle system is moving along a route, the vehicle system comprising plural vehicles configured to move together along the route, wherein two or more vehicles of the vehicle system are each configured to contribute a predetermined amount of effort to control movement of the vehicle system to move along the route based on the first set of operating conditions, the effort being at least one of tractive effort or braking effort,
the one or more processors configured to determine a revised amount of effort that each of the two or more vehicles of the vehicle system needs to contribute to propel the vehicle system and to control one or more performance variables of the plural vehicles,
responsive to a determination of a revised amount of effort that at least one of the two or more vehicles of the vehicle system needs to contribute to propel the vehicle system to control one or more performance variables of the plural vehicles, the one or more processors configured to change from controlling the vehicle system according to the first set of operating conditions to automatically control operation of the vehicle system according to a second set of operating conditions, at least one of the two or more vehicles contributing the revised amount of effort while the vehicle system operates according to the second set of operating conditions.

13. The control system of claim 12, wherein the one or more processors are configured to one or more of generate or receive the first set of operating conditions including the predetermined amount of effort before the vehicle system starts moving along the route.

14. The control system of claim 12, wherein the one or more processors are configured to determine the revised amount of effort while the vehicle system is moving along the route.

15. The control system of claim 12, wherein the first set of operating conditions includes the predetermined effort for plural locations along the route.

16. The control system of claim 15, wherein the one or more processors are configured to determine the revised effort at one or more of the plural locations along the route.

17. The control system of claim 15, wherein the one or more processors are configured to compare the predetermined amount of effort with the determined revised effort at each of the plural locations, and the one or more processors are configured to determine that the predetermined effort needs to change based on the comparison between the predetermined effort and the determined revised effort.

18. The control system of claim 12, wherein controlling operation of the vehicle system according to the second set of operating conditions changes an amount of force between at least two successive vehicles of the vehicle system relative to controlling operation of the vehicle system according to the first set of operating conditions.

19. The control system of claim 12, wherein controlling operation of the vehicle system according to the second set of operating conditions changes a distance between at least two successive vehicles of the vehicle system relative to controlling operation of the vehicle system according to the first set of operating conditions.

20. A method comprising:
one or more of generating or receiving a first set of operating conditions for controlling operation of a vehicle system according to the first set of operating conditions before the vehicle system starts moving along a route, the vehicle system comprising plural vehicles, the first set of operating conditions specifying a predetermined amount of effort that each of two or more vehicles of the vehicle system is configured to contribute to propel the vehicle system to move along the route;
determining a revised amount of effort that one or more vehicles of the vehicle system needs to contribute to propel the vehicle system to control one or more performance variables of the plural vehicles while the vehicle system is moving along the route; and
changing from controlling the vehicle system according to the first set of operating conditions to automatically controlling operation of the vehicle system according to a second set of operating conditions.
